(19) United States
(12) Patent Application Publication
(10) Pub. No.: US 2011/0261002 A1
(43) Pub. Date: Oct. 27, 2011

(54) DISPLAYING IMAGES ON SOLID SURFACES

(75) Inventor: William George Verthein, Bellevue, WA (US)

(73) Assignee: Microsoft Corporation, Redmond, WA (US)

(21) Appl. No.: 12/767,821

(22) Filed: Apr. 27, 2010

(51) Int. Cl. G06F 3/045; G06F 3/041; G09G 3/20

(52) U.S. Cl. 345/174; 345/55; 345/173

(57) ABSTRACT

An apparatus includes a case that has an outer surface constructed from a substantially opaque material, such as plastic or metal. A flexible, substantially transparent thin display is applied to at least a portion of the outer surface of the case. A substantially transparent touch material is applied to the flexible substantially transparent thin display. The touch material is configured to detect the location of a touch, such as by a finger or a stylus, on the touch material. A substantially transparent protective material is applied to the touch material. The display is substantially transparent when it is not active, thereby permitting the outer surface of the case to be viewed through the display and the protective layer. When portions of the flexible substantially transparent thin display are active, the active portions become substantially opaque, thereby obscuring the view of the outer surface of the case.

### BACKGROUND

Many types of electronics devices are configured with a similar form factor. This form factor typically includes a display screen for providing output to a user and one or more buttons for providing input to the device. Devices utilizing this form factor typically include an outer case made of plastic, metal, or another type of substantially opaque material. The case holds the buttons, the display, and the internal electronic components. For instance, many types of wired and wireless telephones utilize a plastic case to hold the display screen, the buttons, and the internal components.

Devices that utilize the common form factor described above typically utilize only a small portion of the surface of the device for interacting with a user. For instance, telephones typically only have a display on the front surface and buttons on the front and/or side surfaces. As a result, a large portion of the surface area of such a device is not used either for receiving user input or for providing output to a user.

It is with respect to these and other considerations that the disclosure made herein is presented.

### SUMMARY

Technologies are described herein for displaying images on solid surfaces. Through the utilization of the technologies and concepts presented herein, each side of the outer case of an electronic device can be utilized both for providing output to a user and for receiving input from the user. In this manner, the previously unused portions of an electronic device can be utilized for interacting with a user.

According to one aspect presented herein, an apparatus is provided that is capable of displaying images on a solid surface, such as the sides of an electronic device. In one implementation, the apparatus includes a case having an outer surface that is constructed from a substantially opaque material, such as plastic or metal. The apparatus also has a substantially transparent thin display that covers at least a portion of the outer surface of the case. The substantially transparent thin display may be a flexible bistable display material that can be wrapped around curved portions of the outer surface of the case. The apparatus might also include a substantially transparent protective layer that covers the flexible substantially transparent thin display.

According to embodiments, the apparatus also includes a display controller enclosed within the case and coupled to the flexible substantially transparent thin display through a port in the case. The display controller is configured to drive the thin display by providing an appropriate signal to the thin display. When the flexible substantially transparent thin display is not driven by the display controller, the flexible substantially transparent thin display is substantially transparent, thereby permitting the outer surface of the case to be viewed through the flexible substantially transparent thin display and the substantially transparent protective layer. When portions of the flexible substantially transparent thin display are active (i.e. driven by the display controller), the active portions of the thin display become substantially opaque, thereby obscuring the view of the outer surface of the case. When the display is opaque (i.e. active), the color of the display is typically in contrast to the color of the opaque case material so that the image is visible (black dots on white case, white dots on black case, for instance). In this manner, virtually the entire outer surface of the case of an electronic device can be utilized to provide a display to a user.

According to embodiments, the apparatus also includes a substantially transparent touch material located between the flexible substantially transparent thin display and the protective layer. The touch material is configured to detect the location of a touch, such as by a finger or a stylus, on the touch material. The touch material may comprise a capacitive touch film, for instance. An input interface might also be coupled to the touch material that is configured to receive a signal from the touch material indicating the location of the touch on the touch material.

A central processing unit (“CPU”) or other type of processor might also be utilized within the apparatus to receive signals from the input interface and to provide output signals to the display controller. For instance, the CPU might execute program code for causing a display to be presented by all or a portion of the flexible substantially transparent thin display. The program code might also receive signals from the input interface indicating that a touch has been made on the touch material. In response thereto, the CPU might cause the display controller to modify the display presented by the flexible substantially transparent thin display. A haptic actuator might also be coupled to the CPU in order to provide tactile feedback to a user of the apparatus.

According to embodiments, the display output generated by the flexible substantially transparent thin display might show user interface controls for interacting with and controlling the operation of the apparatus. The display might also be a game image, alphanumeric information, simulated case material, an image, a virtual pet, or virtually any other type of information. As described briefly above, the display provided by the flexible substantially transparent thin display might be modified in response to detecting touch input on the touch material.

It should be appreciated that the above-described subject matter may also be implemented in various other embodiments without departing from the spirit of the disclosure. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1 and 2 are cross-sectional views of an apparatus capable of displaying images on a solid surface that has been configured according to several embodiments presented herein;

FIGS. 3A-3D are images of a desktop telephone that has been configured to display images on a solid surface in accordance with the embodiments presented herein;

FIG. 4 is a flow diagram showing one method provided herein for constructing an apparatus capable of displaying images on a solid surface; and

FIG. 5 is a schematic diagram showing additional aspects of the configuration of an apparatus provided herein in embodiments that is capable of displaying images on a solid surface.

### DETAILED DESCRIPTION

The following detailed description is directed to technologies for displaying images on solid surfaces. In the following detailed description, references are made to the accompanying drawings that form a part hereof, and which are shown by way of illustration specific embodiments or examples. Referring now to the drawings, in which like numerals represent like elements through the several figures, aspects of an apparatus and a method for displaying images on solid surfaces will be described.

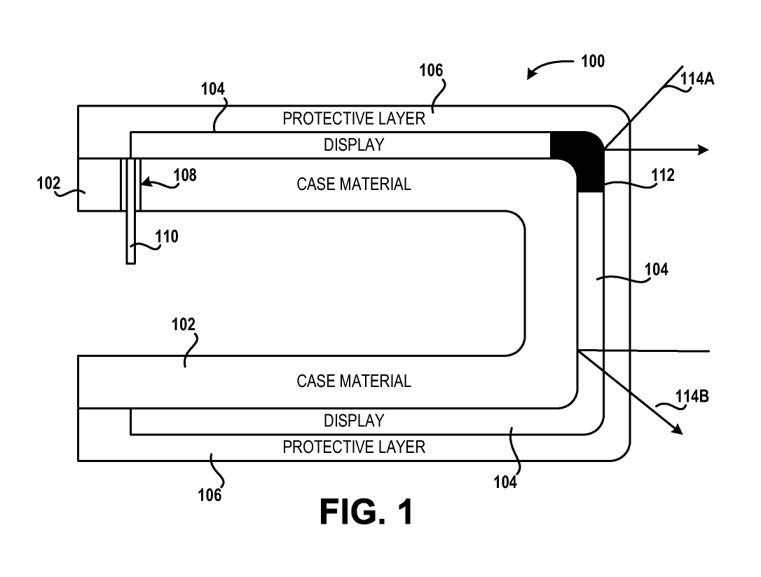

Turning now to FIG. 1, details will be provided regarding one embodiment presented herein for displaying images on solid surfaces. FIG. 1 is a cross-sectional view of an apparatus capable of displaying images on a solid surface that has been configured according to one embodiment presented herein. In particular, FIG. 1 shows an arrangement 100 of materials for use in displaying images on a solid surface. The arrangement 100 includes a substantially opaque case material 102. The case material 102 is utilized to form a case for enclosing the electronic components of an electronic device. The case material 102 may comprise any substantially opaque material from which a case for an electronics device may be constructed including, but not limited to, metal, plastic, wood, ceramics, and other materials. The case material 102 may be formed into multiple parts that together form the case.

As also shown in FIG. 1, the arrangement 100 includes a display 104 that has been molded to the case material 102. According to one implementation, the display 104 is a substantially transparent thin display that is sufficiently flexible to be molded to the contour of the case material 102. For instance, in one implementation, the display 104 comprises a flexible bistable display. As known to those skilled in the art, bistable displays are flexible and can therefore be formed to the contours of a case made from the case material 102. Bistable displays are also transparent and can operate using only a minimal amount of power. It should be appreciated that the pixel color of the bistable display utilized in embodiments presented herein may be black, white, or a color. It should also be appreciated that the display 104 may comprise other types of displays that are substantially transparent when inactive, thin, and flexible enough to be wrapped around the curved portions of an outer surface of the case of an electronic device.

According to one implementation, the arrangement 100 also includes a protective layer 106 that covers the flexible substantially transparent thin display 104. The protective layer 106 may comprise a substantially transparent plastic or another type of material that can provide appropriate protection for the display 104.

As will be described in greater detail below, an electronic device constructed using the arrangement 100 shown in FIG. 1 might also include a display controller (not shown in FIG. 1) enclosed within the case material 102 that is coupled to the display 104 through a port 108 in the case material 102. An appropriate connector 110 may be passed through the port 108 to enable an electrical connection between the display 104 and the display controller. When the display 104 is not driven by the display controller, the display 104 is substantially transparent, thereby permitting the outer surface of the case material 102 to be viewed through the display 104 and the protective layer 106. For instance, a light ray 114B shown in FIG. 1 may pass through the protective layer 106, the display 104, and be reflected from the case material 102. In this manner, the outer surface of the case material can be viewed through the display 104 and the protective layer 106.

When portions of the display 104 are active, the active portions of the display 104 become substantially opaque. In this manner, the active portions of the display 104 obscure the view of the outer surface of the case material 102. For instance in the example shown in FIG. 1, the light ray 114A passes through the protective layer 106, but is reflected by the portion 112 of the display 104 that is active. As described briefly above, when the display is opaque (i.e. active), the color of the display is typically in contrast to the color of the opaque case material so that the image is visible (black dots on white case, white dots on black case, for instance). Through the use of the arrangement 100 shown in FIG. 1, images or text displayed by the display 104 will therefore appear to emerge from the outer surface of the case material 102. Since the display 104 and the protective layer 106 are flexible and can be wrapped around curved portions of the case material 102, the device constructed utilizing the arrangement 100 shown in FIG. 1 can have images displayed on its curved surfaces, thereby enabling innovative industrial design. Additional details regarding the functionality provided by the arrangement 100 will be provided below.

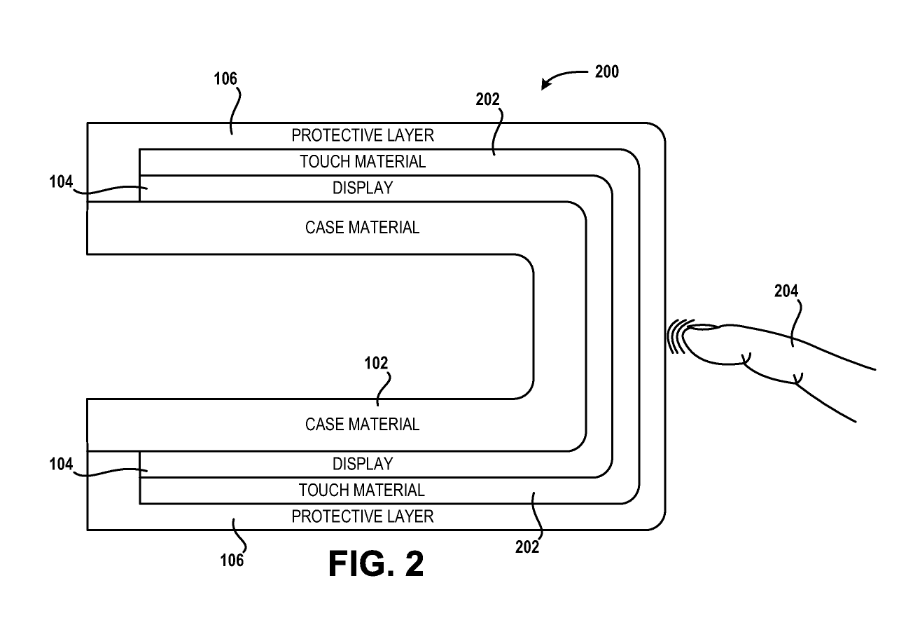

FIG. 2 shows another cross-sectional view of an apparatus capable of displaying images on a solid surface that has been configured according to an embodiment presented herein. In particular, FIG. 2 shows an arrangement 200 that is similar to the arrangement 100 illustrated in FIG. 1 and described above. The arrangement 200, however, includes a touch material 202 placed between the display 104 and the protective layer 106. The touch material 202 is configured to detect the location of a touch, such as by a finger 204 or a stylus, on the touch material 202. In one embodiment, the touch material 202 comprises a substantially transparent capacitive touch film. It should be appreciated, however, that other types of materials that are touch sensitive, substantially transparent, and suitably flexible to be wrapped around the curved portions of the case of an electronic device may also be utilized.

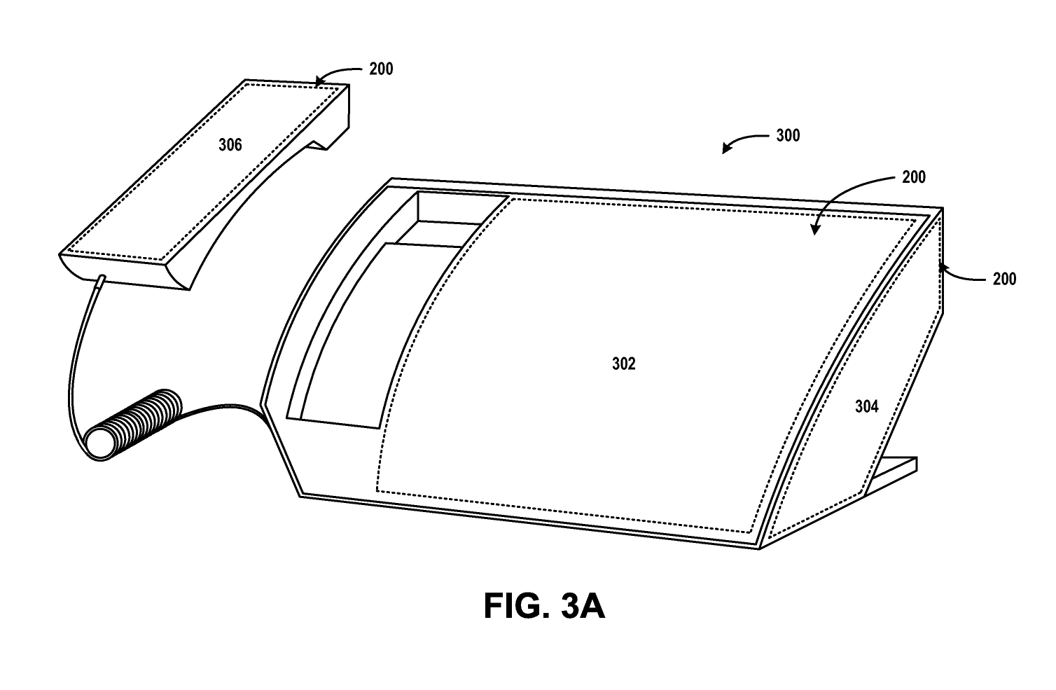

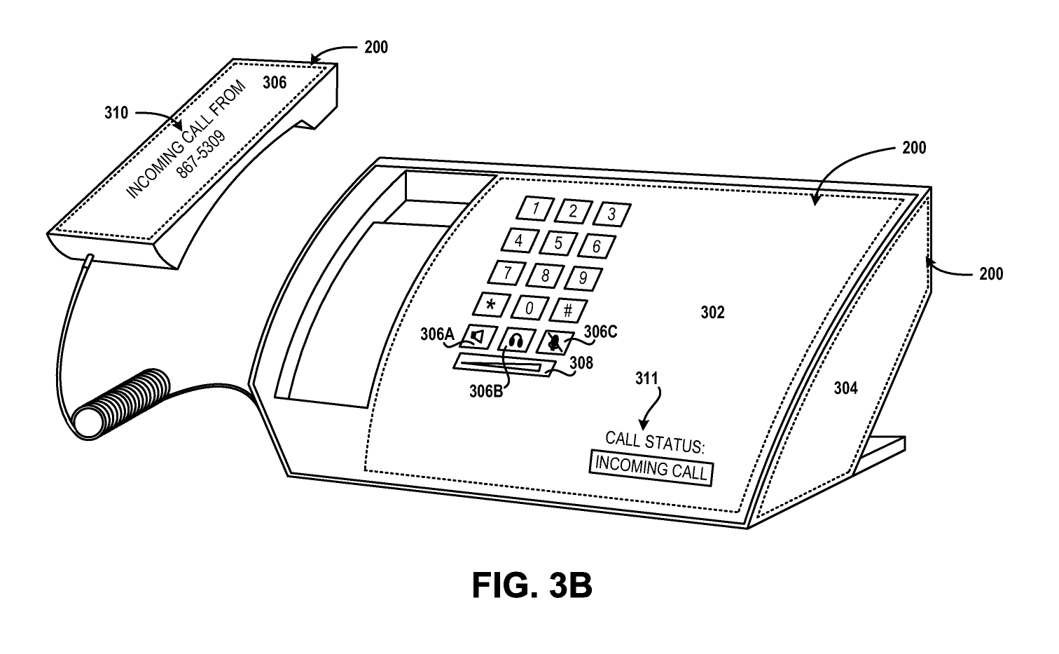

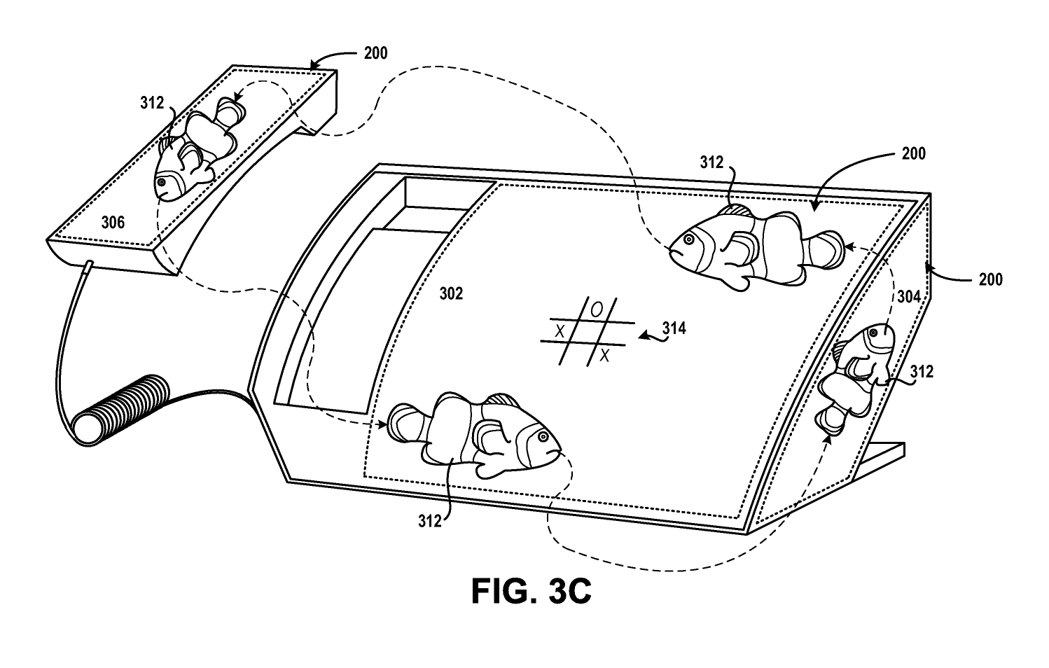

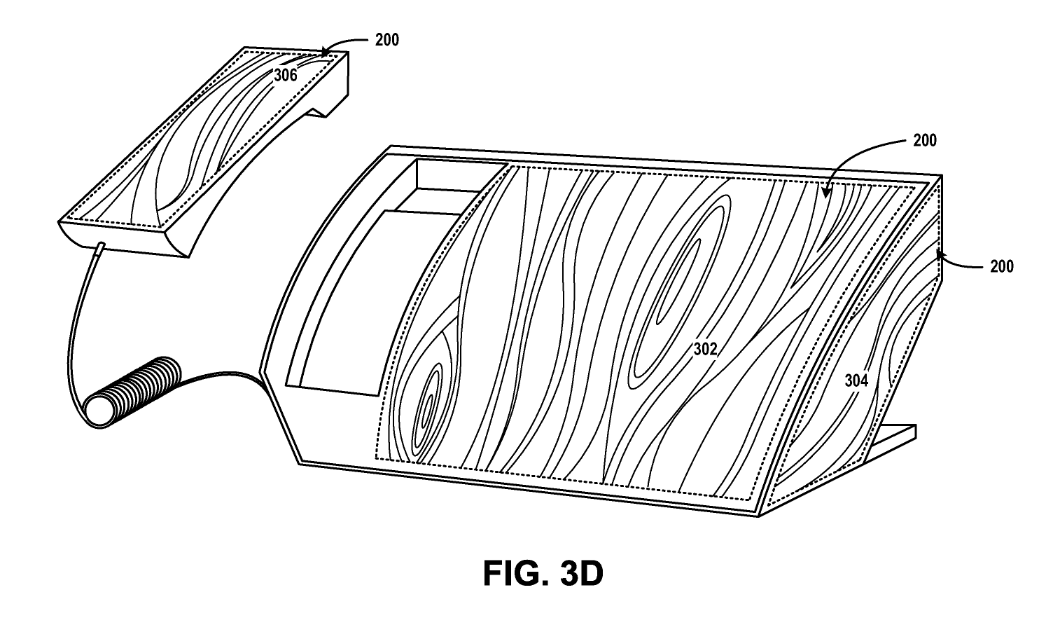

According to one implementation, an input interface (not shown in FIG. 2) is also located within a case formed by the case material 102 that is configured to receive a signal, or signals, from the touch material 202 indicating the location of the touch on the touch material 202. Through the use of the display 104 and the touch material 202, images can be displayed by an apparatus configured as illustrated in FIG. 2 and manipulated. For instance, the types of images that may be displayed and manipulated include, but are not limited to, user interface buttons that can be pressed, slide controls that may be slid, and interactive pictures that react to touch on the case. Additional details regarding the various uses of the arrangement 200 will be provided below with respect to FIGS. 3A-3D. As will also be described below, a haptic actuator (not shown in FIG. 2) may also be provided in the case for providing feedback to a user of an apparatus constructed utilizing the arrangement 200.

As will also be described in greater detail below, a central processing unit or other type of processor may also be utilized within an apparatus configured in accordance with the arrangement 200 to receive signals from the input interface and to provide output signals to the display controller. For instance, the CPU might execute program code for causing a display to be presented by all or a portion of the display 104. The executing program code might also receive signals from the input interface indicating that a touch has been made on the touch material 202. In response thereto, the CPU might cause the display controller to modify the display presented by the thin display 104. The haptic actuator might also be coupled to the CPU in order to provide tactile feedback to a user of the apparatus in response to the touch.

FIGS. 3A-3D are images of a desktop telephone 300 that has been configured in accordance with the arrangement 200 to display images on a solid surface. It should be appreciated that a desktop telephone is utilized herein only to describe various features that might be provided utilizing the arrangements 100 and 200 shown in FIGS. 1 and 2. It should be appreciated that a desktop telephone is only one application of the embodiments presented herein, and that the arrangements 100 and 200 might be utilized with virtually any other type of electronic device. For instance, and without limitation, the embodiments presented herein might be utilized with wireless mobile telephones, audio players, portable video devices, laptop, desktop, tablet and server computing systems, e-book readers, home appliances, set top boxes, televisions, optical disk players and recorders, and virtually any other type of electronic device.

As will be described in greater detail below, the addition of the flexible substantially transparent thin display 104 and the touch material 202 to an electronic device enables many possible innovative features to be expressed on all of the outer surfaces of the device. As also described briefly above, an optional haptic actuator can also provide feedback to a user of such a device. Audible feedback might also be provided from an integrated speaker.

Turning now to FIG. 3A, additional details regarding a desktop telephone 300 configured utilizing the arrangement 200 will be described. As shown in FIG. 3A, the desktop telephone 300 includes a base station and a handset. The base station and the handset of the desktop telephone 300 are constructed from the case material 102. As discussed briefly above, the case material 102 is substantially opaque and might include such materials, such as plastic, wood, ceramics, or metal.

The desktop telephone 300 illustrated in FIG. 3A includes multiple sides, each of which have a unique geometry and curvature. For instance, the base station of the desktop telephone 300 shown in FIG. 3A has a top side 302, a right side 304, a left side (not shown), a bottom (not shown) and a backside (not shown). The handset of the desktop telephone 300 includes a top 306, four sides, and a bottom. In this example, the top side 302 and the right side 304 of the base station of the desktop telephone 300 have been configured utilizing the arrangement 200 shown in FIG. 2. As discussed above, the base station of the desktop telephone 300 has been configured from a case material 102. A substantially transparent flexible thin display 104 has also been applied to the case material 102. A touch material 202 has been applied over the display 104, and a protective layer 106 has been applied over the touch material 202. As described above, when the display 104 is in an inactive state, the case material 102 of the base station of desktop telephone 300 will be visible through the protective layer 106, the touch material 202, and the display 104. As will be described in greater detail below with respect to FIGS. 3B-3D, when portions of the display 104 are active, the displayed images will appear on the outer surface of the case material 102.

As also illustrated in FIG. 3A, the top 306 of the handset of the desktop telephone 300 has also been configured in accordance with the arrangement 200 shown in FIG. 2. In this manner, images might also be displayed on the top 306 of the handset. Although not shown in the configuration illustrated in FIG. 3A, it should be appreciated that the arrangement 200 might also be applied to the other sides of the base station and handset of the desktop telephone 300.

Turning now to FIG. 3B, details regarding the types of displays that might be provided utilizing the arrangement 200 will be described. For instance, in the embodiment illustrated in FIG. 3B, buttons have been presented by the display 104 on the top side 302 of the base station of the desktop telephone 300. In particular, in this example, a standard telephone keypad has been displayed. The telephone keypad includes the standard telephone numbers and additional function buttons 306A-306C, corresponding to functions for placing a call on speaker, utilizing a headset, and muting a microphone. A slider user interface control 308 has also been displayed that allows a user to change the volume of an incoming call. It should be appreciated that portions of the display utilized to display the keypad and the buttons 306A-306C and the slider user interface control 308 are substantially opaque, thereby obscuring the case material 102. It should be appreciated that the other portions of the arrangement 200 applied to the top side 302 of the case are substantially transparent, thereby permitting the case material 102 to be viewed there through.

In the example shown in FIG. 3B, alphanumeric information 311 has also been displayed on the top side 302 of the desktop telephone 300. In this example, the alphanumeric information 311 indicates that a call is incoming Alphanumeric information 310 has also been displayed on the top side 306 of the handset of the desktop telephone 300. The alphanumeric information 310 indicates that a call is incoming and identifies the telephone number of the originating party.

It should be appreciated that, through the use of the touch material 202, a user may interact with the buttons presented on desktop telephone 300 by way of the display 104. For instance, a user may utilize a finger or a stylus to dial a telephone number or interact with the buttons 306A-306C or the slider user interface control 308. Optional haptic and auditory feedback may be provided in order to provide feedback during use of the buttons and other user interface controls displayed on the desktop telephone 300.

It should be appreciated that, in other embodiments, other telephone controls might be displayed. For instance, legacy rotary telephone controls might be displayed on the surface of the desktop telephone 300. Optional haptic and auditory feedback might be utilized to provide simulation or knob detent clicking as the virtual control is “turned” by moving a user's finger or stylus on surface of the desktop telephone 300. Other types of slider user interface controls might also be displayed for performing other functions, such as sound equalization. Optional haptic and auditory feedback can provide simulation or knob detent clicking when the virtual control is “slid” by moving a user's finger or a stylus on the surface of the desktop telephone 300.

Turning now to FIG. 3C, additional details will provided regarding the types of displays that may be provided on an electronic device utilizing the arrangement 200 shown in FIG. 2. In particular, utilizing the embodiments presented herein, images can be displayed by the display 104 and interacted with utilizing the touch material 202. The touch material 202 might be utilized to pan or zoom the image. For instance, dragging one finger across the surface of a suitably configured device can cause the image to pan side to side or up and down. Two fingers drawn together or apart on the surface of the device itself can cause the image to zoom out or in. Appropriate haptic and/or audio feedback can accompany the pan and or zoom.

According to other implementations, swirl, smear, and blur effects might also be provided for images displayed on the display 104. For instance, swirling a finger on an image might cause the image to be distorted. Haptic and audio feedback can optionally enhance the swirl, smear, or blur. An image shown on the surface of a suitably configured device may also be rotated by either moving a finger offset from the image center in an arc, or by moving two fingers around the center of the image. Haptic and/or audio feedback can be added to enhance the effect. An image might also be “erased” by moving a finger or stylus over the display of the image on the case of the device. In other embodiments, a finger or stylus might also be utilized to “write” on the surface of a device configured utilizing the arrangement 200. For instance, using a suitably configured desktop telephone, a user might write notes, phone numbers, or other information directly on the top side 302 of the desktop telephone.

According to another implementation, an image of an animal or other type of virtual pet might be displayed utilizing the arrangement 200. For instance, in the example shown in FIG. 3C, an image 312 of a fish has been displayed on the desktop telephone 300. In this example, the image 312 has been animated so that it moves across the top side 302, the right side 304, and the top side 306 of the handset. In this manner, an image, such as a virtual pet, might appear to “swim” or otherwise move across the various surfaces of an electronic device configured using the arrangement 200.

The image 312 might also be programmed to follow or avoid a touch detected by the touch material 202. A flick of a finger or stylus might also cause the image 312 to be cast off of the desktop telephone 300. It should be appreciated that many other types of interactions with images displayed on a device configured using the embodiments provided herein are also possible.

As also shown in FIG. 3C, games that lend themselves to touch can be expressed on any surface of a suitably configured device. For instance, in the example shown in FIG. 3C, a game 314 of tic-tac-toe has been displayed on the top side 302 of the base station of the desktop telephone 300. Other games, such as checkers, chess, solitaire, tile slide puzzles, and others might also be displayed and interacted with utilizing the arrangement 200.

Turning now to FIG. 3D, another utilization of the arrangement 200 will be described. In particular, in the embodiment shown in FIG. 3D, a simulated case material has been displayed on the top side 302 and right side 304 of the base station of the desktop telephone 300 and on the to side 306 of the handset. The simulated case material illustrated in FIG. 3D is wood. In this manner, the arrangement 200 shown in FIG. 2 can be utilized to display an image of a different material than the case material 102.

Depending upon the type of simulated case material displayed, feedback might also be provided that simulates a touch of the simulated material. For instance, in the case of wood grain, haptic feedback might be provided simulating the touch and feel of this material. Simulated case material might also extend to images of physical attributes of the case that are actually not present in the actual case surface. For instance, images of ridges, bezels, and other physical attributes of a case may be generated by the display 104. Haptics may be enabled to provide subtle feedback suitable for the touching of the simulated case material. It should be appreciated that the examples shown in FIGS. 3A-3D and described above are merely illustrative and that many other types of displays might be provided utilizing the arrangements 100 and 200 discussed above.

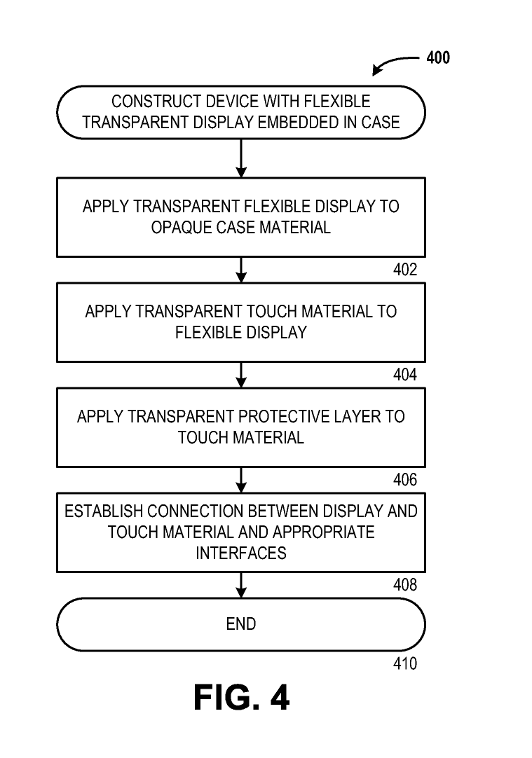

Referring now to FIG. 4, an illustrative routine 400 will be described that illustrates one process for constructing a device with a flexible transparent display embedded into a case material 102 as described above. The routine 400 begins at operation 402, where the flexible transparent thin display 104 is applied to a case material 102. The display 104 might be applied to the case material 102 utilizing an appropriate adhesive, a thermal bonding process, a vacuum bonding process, or another process known in the art. It should be appreciated that, when bonded to the case material 102, the display 104 remains suitably transparent when inactive. In this manner, the case material 102 can be viewed through the display 104 when inactive. When portions of the display 104 are activated, the remainder of the display remains substantially transparent, thereby obscuring the case material 102 where the display 104 is active.

From operation 402, the routine 400 proceeds to operation 404 where the transparent touch material 202 is applied to the display 104 in one embodiment. As discussed above, the touch material 202 is substantially transparent, thin, and sufficiently flexible to be applied to a curved surface of the case material 102. The touch material 202 might be applied to the display 104 utilizing an appropriate adhesive, vacuum or heat bonding process, or another appropriate process known to those skilled in the art.

From operation 404, the routine 400 proceeds to operation 406, where the protective layer 106 is applied to the touch material 202. As described above, the protective layer 106 is thin, substantially transparent, and sufficiently flexible to be bonded to the curved surface of the touch material 202. An appropriate adhesive or vacuum bonding process might also be utilized to apply the protective layer 106 to the touch material 202. Other appropriate processes suitable for bonding a protective layer 106 to the touch material 202 might also be utilized. It should be appreciated that the protective layer 106 might also be integrated directly within the touch material 202.

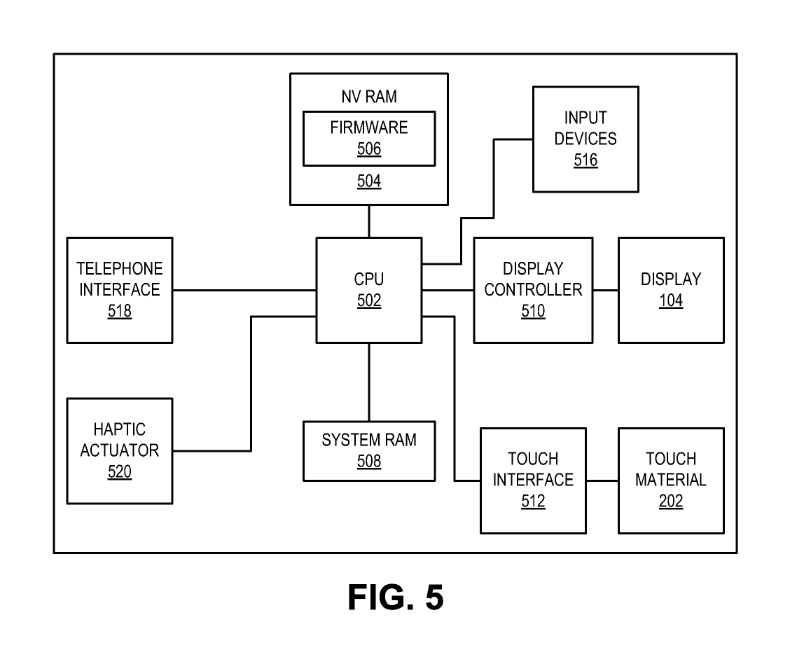

Once the transparent protective layer 106 has been mated to the touch material 202, a connection can be established between the display 104 and the touch material 202 and the appropriate interfaces contained within the case of the electronic device. As discussed above, the case material 102 might include a suitable port 108 through which connectors may be passed for connecting the touch material 202 and the display 104 to the controllers within the case. Additional details regarding the structure and configuration of the electronic components mounted within the case material 102 will be provided below with respect to FIG. 5. From operation 408, the routine 400 proceeds to operation 410, where it ends.

FIG. 5 is schematic diagram showing additional aspects of the configuration of an apparatus provided herein in embodiments that is capable of displaying images on a solid surface, such as the case material 102. As shown in FIG. 5, an exemplary apparatus includes the display 104 and the touch material 202. The display 104 and the touch material 202 may be configured in the manner described above with reference to FIGS. 1 and 2. In order to drive the display 104, a suitable display controller 510 is also provided. As discussed above, the display controller 510 may be connected to the display 104 by way of a connector 110 that passes through a port 108 in the case material 102. Similarly, a touch interface 512 may be provided for receiving signals from the touch material 202 regarding the location and possibly pressure of a touch on the touch material 202. A suitable connector for connecting the touch interface 512 to the touch material 202 may also pass through the port 108.

As also illustrated in FIG. 5, a CPU 502 is connected to the display controller 510 and the touch interface 512. A non-volatile random access memory (“NVRAM”) is also connected to the CPU 502 that includes a firmware 506. The firmware 506 includes instructions that are executable by the CPU 502 for controlling the operation of the display controller 510 and the touch interface 512. In particular, the firmware 506 might cause the CPU 502 to provide instructions to the display controller 510 for providing any of the displays described herein. The firmware 506 might also cause the CPU 502 to receive signals from the touch interface 512 and to modify the display provided by the display controller 510 and the display 104 in response thereto. The CPU 502 might utilize a system RAM 508 during its processing and execution of the firmware 506.

As illustrated in FIG. 5, one or more input devices 516 might also be connected to the CPU 502 through an appropriate interface. For instance, physical buttons present on an apparatus configured in accordance with the embodiments presented herein may be connected to the CPU 502. As also shown in FIG. 5, an appropriate haptic actuator 520 might also be connected to the CPU 502 through an appropriate interface. As discussed above, the haptic actuator 520 might be utilized to provide feedback to a user of the apparatus in response to touches made on the touch material 202.

In an embodiment wherein the apparatus comprises a desktop or wireless telephone, the apparatus might also include an appropriate telephone interface 518 for connecting to an appropriate telephone network. It should be appreciated that the configuration illustrated in FIG. 5 is merely illustrative and that this configuration has been simplified for the discussion presented herein. It should also be appreciated that the configuration shown in FIG. 5 might include fewer or additional components than illustrated and described herein or may be configured in an entirely different manner. Other configurations will be apparent to those skilled in the art.

Based on the foregoing, it should be appreciated that technologies for displaying images on solid surfaces have been presented herein. The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. An apparatus capable of displaying images on a solid surface, the apparatus comprising:
a case constructed from a substantially opaque material and having an outer surface;
a flexible substantially transparent thin display covering a portion of the outer surface of the case; and
a substantially transparent protective layer covering the flexible substantially transparent thin display.

2. The apparatus of claim 1, further comprising a display controller enclosed within the case, the display controller coupled to the flexible substantially transparent thin display through a port in the case and configured to drive the flexible substantially transparent thin display.

3. The apparatus of claim 2, further comprising a substantially transparent touch material located between the flexible substantially transparent thin display and the protective layer, the touch material being configured to detect the location of a touch on the touch material.

4. The apparatus of claim 3, further comprising an input interface coupled to the touch material through the port and configured to receive a signal from the touch material indicating the location of the touch on the touch material.

5. The apparatus of claim 4, wherein the flexible substantially transparent thin display is substantially transparent when not driven by the display controller, and wherein a portion of the flexible substantially transparent thin display is substantially opaque when driven by the display controller.

6. The apparatus of claim 5, wherein the flexible substantially transparent thin display comprises a flexible bistable display.

7. The apparatus of claim 6, wherein the touch material comprises a capacitive touch film.

8. The apparatus of claim 7, further comprising a haptic actuator configured to provide haptic feedback in response to a touch being detected by the touch material.

9. The apparatus of claim 8, further comprising:
a memory storing a firmware comprising computer-executable instructions; and
a central processing unit connected to the display controller, the input interface, and the memory, and configured to execute the computer-executable instructions from the memory to thereby cause an image to be displayed by the flexible substantially transparent thin display and to further cause the displayed image to be modified in response to receiving a signal from the touch material indicating a touch on the touch material.

10. The apparatus of claim 9, wherein the image comprises a user interface control for controlling operation of the apparatus.

11. The apparatus of claim 9, wherein the image comprises a game image.

12. The apparatus of claim 9, wherein the image comprises simulated case material.

13. The apparatus of claim 9, wherein the image comprises alphanumeric information.

14. A method for constructing an apparatus capable of displaying images on a solid surface, the method comprising:
applying a flexible substantially transparent thin display to a portion of an outer surface of a substantially opaque case; and
applying a substantially transparent protective layer to the flexible substantially transparent thin display, whereby the case is visible through the flexible substantially transparent thin display and the substantially transparent protective layer when the flexible substantially transparent thin display is inactive, and wherein a display generated by the flexible substantially transparent thin display is visible through the substantially transparent protective layer.

15. The method of claim 14, further comprising applying a substantially transparent touch material to the flexible substantially transparent thin display prior to applying the substantially transparent protective layer, and wherein the substantially transparent protective layer is applied to the substantially transparent touch material, the touch material configured to detect the location of a touch on the touch material.

16. The method of claim 15, further comprising connecting the flexible substantially transparent thin display to a display controller enclosed within the case, the display controller configured to drive the flexible substantially transparent thin display.

17. The method of claim 16, further comprising connecting the substantially transparent touch material to an input interface enclosed within the case, the input interface configured to receive a signal from the touch material indicating the location of the touch on the touch material.

18. The method of claim 17, wherein the flexible substantially transparent thin display comprises a flexible bistable display.

19. The method of claim 18, wherein the touch material comprises a capacitive touch film.

20. An apparatus capable of displaying images on a solid surface, the apparatus comprising:
a case constructed from a substantially opaque material and having an outer surface;
a flexible substantially transparent thin display covering a portion of the outer surface of the case, the substantially transparent thin display comprising a flexible bistable display;
a substantially transparent touch material covering the substantially transparent thin display, the substantially transparent touch material comprising a capacitive touch film configured to detect the location of a touch on the touch material; and
a substantially transparent protective layer covering the substantially transparent touch material.
